(19) United States
(12) Patent Application Publication
(10) Pub. No.: US 2013/0055864 A1
(43) Pub. Date: Mar. 7, 2013

(54) MACHINE FOR STAMPING AND/OR NIBBLING A WORKPIECE AND METHOD FOR ACTUATING THE SAME

(71) Applicant: Bert Brahmer, Bruchsal (DE)

(72) Inventor: Bert Brahmer, Bruchsal (DE)

(73) Assignee: VOITH PATENT GMBH, Heidenheim (DE)

(21) Appl. No.: 13/515,099

(22) PCT Filed: Apr. 28, 2011
(86) PCT No.: PCT/EP11/56744

§ 371 Date: Jun. 11, 2012

(51) Int. Cl. B23D 27/00; B23D 36/00

(52) U.S. Cl. 83/13; 83/523

(57) ABSTRACT

A stamping and/or nibbling machine, with a Z-axis drive for driving a tool, which is movable in the vertical direction and can be held by a tool holder, for the machining of sheet metal workpieces, with a first CNC control unit for actuating the Z-axis drive, wherein the first CNC control unit provides an interface for a data channel to a primary control unit or to a second CNC control unit of an X/Y-axis drive for moving the sheet metal workpieces relative to the tool in horizontal directions (X, Y), wherein the tool holder, during a vertical movement during the machining of sheet metal workpieces, is rotatable around its vertical longitudinal axis by a C-drive which is actuated by the second CNC control unit, as a result of which an angle sensor is provided for detecting the angle information of the C-drive and the first CNC control unit is designed in such a way that from the angle information it determines a Z-setpoint value as a reference variable of the Z-axis drive. The invention also refers to a method for actuating such a stamping and/or nibbling machine.

### BACKGROUND

The present invention relates to a stamping and/or nibbling machine and method for actuating a stamping and/or nibbling machine.

The invention refers to a stamping and/or nibbling machine, with a Z-axis drive for driving a tool, which is movable in the vertical direction and can be held by a tool holder, for the machining of sheet metal workpieces. The invention also refers to a method for actuating such a stamping and/or nibbling machine.

### SUMMARY

Such machines usually have a first CNC control unit for actuating the Z-axis drive. The first CNC control unit can provide an interface for a data channel to a primary control unit, especially a PLC control unit, or to a second CNC control unit of an X/Y-axis drive. By the X/Y-axis drive the sheet metal workpieces which are to be machined are moved relative to the tool in horizontal directions, that is to the X/Y axes. The sheet metal workpieces in this case can be moved especially in a horizontal plane. It is also conceivable that the sheet metal workpieces which are to be machined are in a band-like form and are unrolled from a coil. The X-axis drive can then effect the forward feed of the workpieces, for example, whereas the Y-axis drive then moves the tool over the workpieces transversely to the forward feed of the band, for example. The tool holder, during a vertical movement during the machining of the sheet metal workpieces, can be rotated around its vertical longitudinal axis by a C-drive in the process. The second CNC control unit actuates the C-drive in addition to the X/Y-axis drives.

Depending upon the construction of the machine, a T-drive selects one of a plurality of tools from a tool magazine or tool turret.

In the case of previously known machines, as already mentioned, the first CNC control unit of the Z-axis drive is designed separately from the second CNC control unit of the X/Y-axis drive, of the C-drive and, if applicable, of the T-drive. This has to do with the fact that for the Z-axis drive a different drive technology is regularly applied than for the rest of the drives. The Z-axis drive is usually formed by hydraulically or pneumatically pressurizable press rams which provide a comparatively high stamping force in the range of between 150 and 350 kN, for example. In order to enable time-harmonized actuation of the Z-axis drive with the other drives, it is known to provide a data channel, for example a field bus, between the two CNC control units. Via this data channel, for example, the first CNC control unit for the Z-axis drive is supplied with parameters such as data for the top dead center and the bottom dead center of a stamping stroke or with the position for a tool change. During the machining of the sheet metal workpieces, coordination is essentially via discrete start and stop signals, which in most cases exist in the form of digital signals. An exchange of position data in real time in order to provide axis synchronization, does not take place.

Depending upon the type of tool used, it may be necessary that the tool has to be rotated along its longitudinal axis during the machining Especially when the tool is a thread cutter, this is to be rotated to the right, for example, during the downward travel and during the upward travel is to be rotated back again to the left. The use of such tools therefore requires a synchronized movement of the C-axis and the Z-axis.

In the case in which the C-axis drive and the Z-axis drive are actuated by a common CNC control unit, such synchronization is readily possible. As described in the introduction, with the majority of stamping and/or nibbling machines, however, it is provided that provision is made for two separate CNC control units, these being a first CNC control unit for the Z-axis and a second CNC control unit for the X/Y-axis, the C-axis and, if applicable, the T-axis. In such a case, it is provided that the second CNC control unit of the X/Y-axis, via a suitable interface, transmits the position of the C-axis in real time to the first CNC control unit of the Z-axis. The first CNC control unit of the Z-axis can then independently calculate the Z-setpoint value from the C-actual value. It is also conceivable that the second CNC control unit of the X/Y-axis directly calculates the necessary Z-setpoint value and transmits it to the first CNC control unit of the Z-axis. In both mentioned cases, however, a real time-capable interface is to be provided in the case of both first and second CNC control units. A real time-capable interface is distinguished by the fact that the position values are transmitted isochronously, that is to say with equal time intervals, and with a sufficiently small distance of time, in the region of a few milliseconds or fractions of milliseconds. As a rule, such a desirable interface cannot be produced since the two separate CNC control units are usually subjected to technical limitations or do not have the suitable interfaces, especially on account of different manufacturers.

The present invention is therefore based on the object of providing a stamping or nibbling machine in which a synchronous movement of Z-axis and C-axis is made available in a simple manner.

This object is achieved by means of a stamping and/or nibbling machine including a Z-axis for driving a tool, the tool moveable in a vertical direction, a tool holder for holding the tool, a C-drive, and a first and second CNC control unit for actuating the C-drive. Such a machine consequently provides that an angle sensor is provided for detecting the angle information of the C-drive, and the first CNC control unit of the Z-axis drive is designed in such a way that from the angle information it determines a Z-setpoint value as a reference variable of the Z-axis drive. By providing an additional angle sensor on the C-drive, the respective position of the C-drive or of the tool carrier, and therefore of the tool, can consequently be referred to in real time without data from the second CNC control unit being used for this purpose. In this respect, it is possible to operate the Z-axis drive and the C-drive in interpolation mode, that is to say synchronously. As already mentioned, a particular advantage of the invention is that reference does not have to be made to data of the second CNC control unit, which actuates the X/Y-axis drive, for this purpose. The Z-setpoint value can consequently be calculated in real time by the first CNC control unit of the Z-axis drive from the angle information.

In the case of the angle sensor, it can be an incrementally operating rotational angle sensor, for example, which detects the respective rotational angle of the C-drive.

It is conceivable in this case that the C-drive has a motor, a drive train, a transmission and/or a rotatable tool holder, wherein the angle sensor can be arranged on the motor, on the drive train, on the transmission or on the rotatable tool holder. Depending upon the position of the angle sensor, conclusions can be drawn from the detected angle information concerning the respective rotational position of the tool, for example of a thread cutter.

It is conceivable in this case that the first CNC control unit is designed in such a way that it determines the Z-setpoint value via a linear transformation and a predetermined pitch, or via a non-linear transformation and a corresponding calculation specification or tables. Especially when threads are cut with the tool, a linear transformation takes place, taking into account the pitch of the thread which is to be provided.

The machine, as already mentioned, can comprise an X/Y-axis drive for moving the sheet metal workpieces relative to the tool in horizontal directions, and also the second CNC control unit of the X/Y-axis drive. In this case, it is to be taken into account that the invention also relates to stamping and/or nibbling machines which do not even comprise such an X/Y-axis drive but which are provided for interacting with such an X/Y-axis drive.

As also mentioned in the introduction, it is conceivable that a T-axis drive, which can be actuated by the second CNC control unit, is provided for the selection of one of a plurality of tools from a tool magazine or tool turret. Such a design has the advantage that the invention can also be used when tool magazines or tool turrets are provided.

The object upon which the invention is based is also achieved by means of a method that actuates a stamping and/or nibbling machine, especially a machine according to the invention, in which a Z-axis drive is actuated for driving a tool, which is movable in the vertical direction and can be held by a tool holder, for the machining of sheet metal workpieces, and the tool holder is rotated around its vertical longitudinal axis by a C-drive in the process. The method is distinguished by the actuation of the Z-axis drive being carried out as a function of angle information of the C-drive. In this case, it is especially provided that from the angle information a Z-setpoint value is determined as a reference variable of the Z-axis drive.

The angle information is detected in this case especially by an angle sensor which is provided on the C-drive. The actuation of the Z-axis drive, as described in the introduction, can be carried out in this case via a first CNC control unit and the angle information forms an input variable of the first CNC control unit.

Also as mentioned in the introduction, it is conceivable that the actuation of the C-drive is carried out via a second CNC control unit which also actuates an X/Y-drive for moving the sheet metal workpieces relative to the tool in horizontal directions.

Furthermore, according to the method according to the invention it can be provided that a data exchange between the first CNC control unit and the second CNC control unit is provided. As also already stated, it is conceivable that the first CNC control unit determines the Z-setpoint value via one of a linear or a non-linear transformation of the angle information and of a pitch which is to be provided.

Further advantages and advantageous embodiments of the invention are to be gathered from the following description, with reference to which an exemplary embodiment of the invention is described and explained in more detail.

### BRIEF DESCRIPTION OF THE DRAWINGS

FIG. 1 illustrates schematically a stamping and/or nibbling machine according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

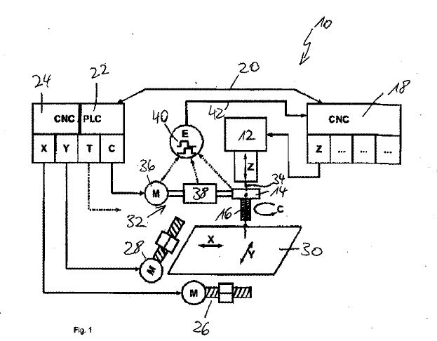

In the figure, a stamping machine 10 according to the invention is shown. The stamping machine 10 comprises a Z-axis drive 12 for driving a tool 16, which is movable in a vertical direction and is held by a tool holder 14. The Z-axis drive 12 is actuated in this case by a first CNC control unit 18. The first CNC control unit 18 in this case is designed so that it actuates additional drives. The first CNC control unit 18 is connected via a data channel 20 to a primary PLC control unit 22. The PLC control unit 22 in its turn is connected to a second CNC control unit 24. In the exemplary embodiment which is shown in FIG. 1, the second CNC control unit 24 and the PLC control unit 22 are accommodated in a housing.

The second CNC control unit 24 actuates an X-axis drive 26 and also a Y-axis drive 28. With these two drives 26 and 28, the sheet metal workpieces 30, which is to be machined, is positioned in a horizontal plane in the X-direction and Y-direction correspondingly beneath the Z-axis drive 12, or beneath the associated tool 16. The second CNC control unit 24 also actuates a C-drive 32, with which the tool holder 14, or the tool 16, is rotated around the vertical longitudinal axis. The C-drive 32 in this case includes in particular a motor 36 and a drive train 38.

An angle sensor 40, which detects angle information of the C-drive 32, is arranged on the motor 36, on the drive train 38 or on the tool holder 14 of the C-drive 32. A data line 42 feeds the angle information to the first CNC control unit 18. From the angle information, the first CNC control unit 18 determines a Z-setpoint value as a reference variable of the Z-axis drive in real time. The actuation of the Z-axis drive 12 is consequently carried out as a function of the angle information of the C-drive 32.

By providing the angle sensor 40 on the C-drive 32 and by transmitting the angle information to the CNC control unit 18, the C-axis and the Z-axis move synchronously in a simple manner without information from the second CNC control unit 24 or from the PLC control unit 22. In this respect, a position of the Z-axis is determined by either the rotational position of the C-drive 32 or of the tool holder 14 or tool 16.

Thus, the invention provides, among other things, a stamping and/or nibbling machine and a method for actuating the stamping and/or nibbling machine. Various features and advantages of the invention are set forth in the following claims.

1. A stamping and/or nibbling machine, the machine comprising:
a Z-axis drive for driving a tool, the tool movable in a vertical direction;
a tool holder for holding the tool;
a C-drive;
a first CNC control unit for actuating the Z-axis drive, wherein the tool holder, during a vertical movement during the machining of a sheet metal workpiece, is rotatable around its vertical longitudinal axis by the C-drive; and
a second CNC control unit for actuating the C-drive, wherein an angle sensor is provided for detecting the angle information of the C-drive and the first CNC control unit is configured to determine from the angle information a Z-setpoint value as a reference variable of the Z-axis drive.

2. The machine as claimed in claim 1, wherein the C-drive includes a motor, a drive train, and a transmission, wherein the angle sensor is arranged on one of the motor, the drive train, the transmission or the tool holder.

3. The machine as claimed in claim 1, wherein the first CNC control unit determines the Z-setpoint value via one of a linear or a non-linear transformation of the angle information.

4. The machine as claimed in claim 1, wherein the first CNC control unit has an interface to one of a primary control unit or to the second CNC control unit.

5. The machine as claimed in claim 1, wherein the second CNC control unit also actuates an X/Y-axis drive for moving the sheet metal workpiece relative to the tool in horizontal directions (X, Y).

6. The machine as claimed in claim 2, wherein the machine includes an X/Y-axis drive. (26, 28) and also the additional

7. The machine as claimed in claim 1, wherein a T-axis drive, is actuated by the second CNC control unit, the T-axis drive providing a selection of one of a plurality of tools from a tool magazine or tool turret.

8. A method for actuating a stamping and/or nibbling machine for machining a workpiece, the method comprising:
actuating a Z-axis drive for driving a tool, which is movable in a vertical direction and held by a tool holder; and
rotating the tool holder around its vertical longitudinal axis by a C-drive, wherein actuation of the Z-axis drive is carried out as a function of angle information of the C-drive.

9. The method as claimed in claim 8, wherein the angle information a Z-setpoint value is determined as a reference variable of the Z-axis drive.

10. The method as claimed in claim 8, wherein the angle information is detected by an angle sensor provided on the C-drive.

11. The method as claimed in claim 8, the actuation of the Z-axis drive is carried out via a first CNC control unit and the angle information forms an input variable of the first CNC control unit.

12. The method as claimed in claim 8, wherein the actuation of the C-drive is carried out via a second CNC control unit which also actuates an X/Y-axis drive for moving the sheet metal workpiece relative to the tool in horizontal directions.

13. The method as claimed in claim 12, wherein a data exchange is carried out between the first CNC control unit and the second CNC control unit.

14. The method as claimed in claim 9, wherein the first control unit determines the Z-setpoint value via one of a linear or a non-linear transformation of the angle information.
